(19) United States
(12) Patent Application Publication
(10) Pub. No.: US 2025/0348054 A1
(43) Pub. Date: Nov. 13, 2025

(54) ANALYSIS AND MANUFACTURE OF CURVED FEATURES FOR INTEGRATED CIRCUITS

(71) Applicant: GlobalFoundries U.S. Inc., Malta, NY (US)

(72) Inventors: Dimitar Petrov Atanassov, Sofia (BG); Apoorva B. Vakil, Halfmoon, NY (US); Bradley A. Orner, Ben Lomond, CA (US); Howard S. Landis, Essex Junction, VT (US); Ian P. Stobert, Hopewell Junction, NY (US); Kevin Kourosh Dezfulian, Arlington, VA (US); Song Ping Tan, Ballston Lake, NY (US); Viktor Ilchev Kolev, Sofia (BG)

(21) Appl. No.: 18/660,942

(22) Filed: May 10, 2024

(51) Int. Cl. G05B 19/18; G06F 30/392

(52) U.S. Cl. CPC G05B 19/188; G06F 30/392; G05B 2219/45031

(57) ABSTRACT

The disclosure provides a method for analysis and manufacture of curved features for integrated circuits. The method includes identifying, within an IC layout, a curved feature including a first endline and a second endline each having at least a threshold length and a curvilinear interval connecting the first endline to the second endline. The method also includes calculating a feature angle and a radius of the curvilinear interval between the first endline and the second endline. Further processing includes determining, based on the feature angle and the radius, whether the curvilinear interval is divisible into a plurality of linear segments each having a same orientation differential relative to the first endline and the second endline. The method additionally includes manufacturing an IC from the layout based on the curvilinear interval and the plurality of linear segments in response to curvilinear interval being divisible into the plurality of linear segments.

### BACKGROUND

The present disclosure relates to integrated circuit (IC) fabrication. More specifically, the present disclosure relates to methods, program products, and systems for controlling IC fabrication.

Fabrication foundries (“fabs”) manufacture ICs using photolithographic processes. Photolithography is an optical printing and fabrication process by which patterns on a photolithographic mask (simply “mask” hereafter) are imaged and defined onto a photosensitive layer coating of a substrate. To manufacture an IC, masks are created using an IC layout as a template. The masks contain the various geometries of the IC layout, and these geometries may be separated with layers of photoresist material.

Through sequential use of the various masks corresponding to a given IC in an IC fabrication process, a large number of material layers of various shapes and thicknesses with different conductive and insulating properties may be built up to form the overall IC and the circuits within the IC layout. Requirements for surface area, feature density, and component size in an IC product may pose technical challenges. Such challenges may include determining whether the design of a particular IC layout is actually capable of being manufactured at an acceptable quality level.

### SUMMARY

Aspects of the disclosure provide a method including: identifying, within an integrated circuit (IC) layout, a curved feature including a first endline and a second endline each having at least a threshold length and a curvilinear interval connecting the first endline to the second endline; calculating a feature angle and a radius of the curvilinear interval between the first endline and the second endline; determining, based on the feature angle and the radius, whether the curvilinear interval is divisible into a plurality of linear segments each having a same orientation differential relative to the first endline and the second endline; and manufacturing an IC from the layout based on the curvilinear interval and the plurality of linear segments in response to curvilinear interval being divisible into the plurality of linear segments.

Further aspects of the disclosure provide a computer program product stored on a computer readable storage medium, the computer program product including program code, which, when being executed by at least one computing device, causes the at least one computing device to: identify, within an integrated circuit (IC) layout, a curved feature including a first endline and a second endline each having at least a threshold length and a curvilinear interval connecting the first endline to the second endline; calculate a feature angle and a radius of the curvilinear interval between the first endline and the second endline; classify, based on the feature angle and the radius, the curvilinear interval as divisible into a plurality of linear segments each having a same orientation differential relative to the first endline and the second endline; and cause a manufacturing device to manufacture an IC from the layout based on the curvilinear interval and the plurality of linear segments in response to curvilinear interval being divisible into the plurality of linear segments.

Additional aspects of the disclosure provide a system including: a computing device; an I/O component operatively coupled to the computing device; and a memory operatively coupled to the computing device, wherein the computing device includes logic and is configured to perform a method including: identifying, within an integrated circuit (IC) layout, a curved feature including a first endline and a second endline each having at least a threshold length and a curvilinear interval connecting the first endline to the second endline; calculating a feature angle and a radius of the curvilinear interval between the first endline and the second endline; determining, based on the feature angle and the radius, whether the curvilinear interval is divisible into a plurality of linear segments each having a same orientation differential relative to the first endline and the second endline; and manufacturing an IC from the layout based on the curvilinear interval and the plurality of linear segments in response to curvilinear interval being divisible into the plurality of linear segments.

### BRIEF DESCRIPTION OF THE DRAWINGS

FIG. 1 illustrates a portion of an IC layout with curved features for analysis according to embodiments of the disclosure.

FIG. 2 provides an expanded view of a curved feature and curvilinear segment in an IC layout under analysis according to embodiments of the disclosure.

FIG. 3 provides a further expanded view of a plurality of linear segments produced from the curvilinear interval of the curved feature according to embodiments of the disclosure.

FIG. 4 provides an example of a curvilinear interval that is divisible into a plurality of linear segments each having a same orientation differential according to embodiments of the disclosure.

FIG. 5 provides an example of a curvilinear interval that is not divisible into a plurality of linear segments each having a same orientation differential according to embodiments of the disclosure.

FIG. 6 depicts a schematic view of an illustrative environment including a computing device for implementing methods according to the disclosure.

FIG. 7 provides an example flow diagram for an operational methodology for implementing methods according to the disclosure.

It is noted that the drawings of the disclosure are not necessarily to scale. The drawings are intended to depict only typical aspects of the invention, and therefore should not be considered as limiting the scope of the invention. In the drawings, like numbering represents like elements between the drawings.

### DETAILED DESCRIPTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings, and it is to be understood that other embodiments may be used and that changes may be made without departing from the scope of the present teachings. The following description is, therefore, merely illustrative.

Embodiments of the disclosure pertain to integrated circuit (IC) (alternatively, “circuit”) manufacture. More specifically, embodiments of the disclosure pertain to a method for analysis and manufacture of curved features for integrated circuits. The method includes identifying, within an IC layout, a curved feature including a first endline and a second endline each having at least a threshold length and a curvilinear interval connecting the first endline to the second endline. The method also includes calculating a feature angle and a radius of the curvilinear interval between the first endline and the second endline. Further processing includes determining, based on the feature angle and the radius, whether the curvilinear interval is divisible into a plurality of linear segments each having a same orientation differential relative to the first endline and the second endline. In other embodiments, such processing includes classifying the curvilinear interval as being divisible into a plurality of linear segments. The method additionally includes manufacturing an IC from the layout based on the curvilinear interval and the plurality of linear segments in response to curvilinear interval being divisible into the plurality of linear segments.

To better illustrate the various embodiments of the present disclosure, particular terminology which may be known or unknown to those of ordinary skill in the art is defined to further clarify the embodiments set forth herein. The term “system” refers to a computer system, server, etc. composed wholly or partially of hardware and/or software components, one or more instances of a system embodied in software and accessible a local or remote user, all or part of one or more systems in a cloud computing environment, one or more physical and/or virtual machines accessed via the internet, other types of physical or virtual computing devices, and/or components thereof. The terms “layout” or “mask layout” refer to a complete or partial mapping of masking material to be used for forming (e.g., by various combinations of etching, deposition, etc.) a particular layer which includes multiple features (“features”). A “manufacturing specification” refers to any user-defined characteristic(s) for distinguishing masks that are viable for manufacture from masks that are not viable for manufacture. Manufacturing specifications may include a comprehensive listing of such measurements, including for example design features, dimensions of particular regions, desired amounts of space to be occupied by fill cells, performance requirements, etc., for all measurable aspects of a device to be manufactured. However, rules in a manufacturing specification for determining whether particular layers are compliant or non-compliant with manufacturing requirements are particularly relevant to embodiments discussed herein. In the example of a front end of line (FEOL) layer (i.e., layers of a device formed before the first metallization and including device components such as transistors, resistors, capacitors, etc.), a manufacturing specification may include a “mask rule” for the layer to be produced. Mask rules refer to dimensional requirements and other measurements for determining whether a particular mask will cause mask inspection problems. In the example of a back end of line (BEOL) layer, i.e., layers of a device after the first metallization, e.g., layers containing wires and vias for coupling functional components together, a manufacturing specification may include a “design rule” for the layer to be produced. Design rules refer to minimum dimensions of devices and interconnects to be formed in an integrated circuit adopted during the design stage and determined by the capabilities of process technology available. Mask rules and design rules are distinct from each other, e.g., by using different types of information about a layout to determine its compliancy or non-compliancy. Mask rules in particular examine an entire mask layout and the spatial relationship between multiple patterns in their final orientation, scale, and tone. In contrast, design rule analysis is usually performed on individual pattern files which may be used to form layouts.

The layout for a particular mask may be obtained from design data and/or generated, modified, etc., with the aid of optical proximity correction (OPC) or other design-enhancement systems. A “feature” generally refers to a functional element in an IC product (e.g., a wire, waveguide, and/or other element for transmitting electricity, radiation, etc.) which must be printed on a wafer using photolithography techniques. A “region” refers to any subset of a given mask. A “pattern” or “feature pattern” refers to a design layout representation of one or more portions of a mask which define the features to be formed in a particular IC product, and which may be formed with the aid of a mask by way of, for example, direct-write electron beam lithography. The patterns in a mask may be structured and positioned to cover underlying materials, and thereby protect them from being etched away while other portions of a layer are being removed.

A “curved feature” refers to any feature, or portion thereof, having a non-linear edge. Within a curved feature, a first endline oriented in a first direction is connected to a second endline oriented in a second (and different) direction through a non-linear edge. The non-linear edge joining the first endline to the second endline is defined herein as an “curvilinear interval.” A “feature angle” refers to the angle between the first endline and the second endline, i.e., the angular differential that a curvilinear interval must traverse as it connects the first endline to the second endline. Each curvilinear interval may have a radius to a center or “focal point” that is located inside the body of the feature (e.g., for an arc that bends outward) or outside the body of the feature (e.g., for an arc that bends inward). All points on a curvilinear interval thus will have a same radius relative to the focal point.

Notwithstanding the presence of curvilinear features in a layout, the size and scale of features in an IC prevent truly curvilinear features from being fabricated. Embodiments of the disclosure improve the manufacturability of IC layouts by identifying curvilinear features and breaking them into a plurality of linear segments, which when positioned together between two endlines, will approximate the curved feature. In addition, embodiments of the disclosure can identify situations where a particular curve cannot be manufactured and enable the layout to be modified for manufacturability, thereby reducing the risk of defects arising from discrepancies between the layout and product.

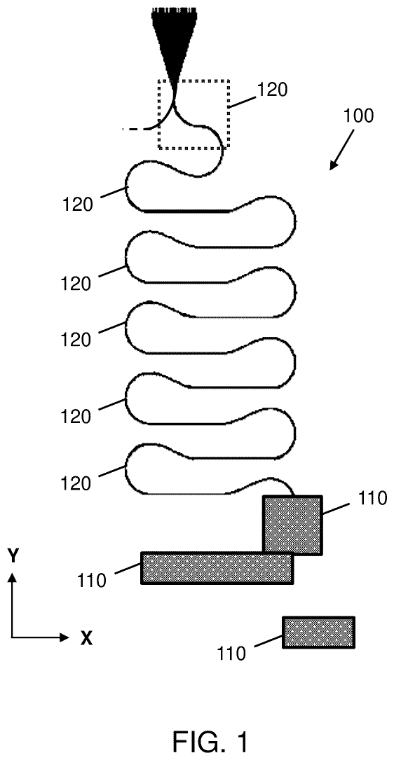

FIG. 1 illustrates a plan view of an IC layout (“layout” hereafter) 100 in plane X-Y, representing at least a portion of a mask to be used in the manufacture of one or more devices. Layout 100 may encompass a given surface area in plane X-Y, and only a portion of layout 100 is shown in FIG. 1 to better illustrate different types of features 110, 120 that may be included within layout 100. Layout 100, furthermore, depicts only one layer of an IC product to be manufactured. Other layers of the same product may be depicted in separate layers, and thus, certain features 110, 120 in layout 100 that appear to be isolated from each other may be interconnected through other features that appear in different layers but are not depicted in layout 100.

At a high level of generality, layout 100 may include non-curved features 110 and curved features 120. Methods of the disclosure pertain to the modeling and processing of curved features 120 (e.g., waveguides and/or other elements of an IC structure having curvilinear intervals therein) such that any curved features 120 in layout 100 are produced successfully by fabrication devices or modified for better manufacturability. According to an example, non-curved features 110 may include photodetectors, logic gates, capacitors, transistors, etc., configured for manufacture with only linear edges. Curved features 120, e.g., a waveguide, by contrast may include several curvilinear pathways. Methods of the disclosure include identifying any curved features 120 in layout 100 and implementing further analysis techniques to create substantially equivalent linear edges in layout 100 that can be successfully manufactured.

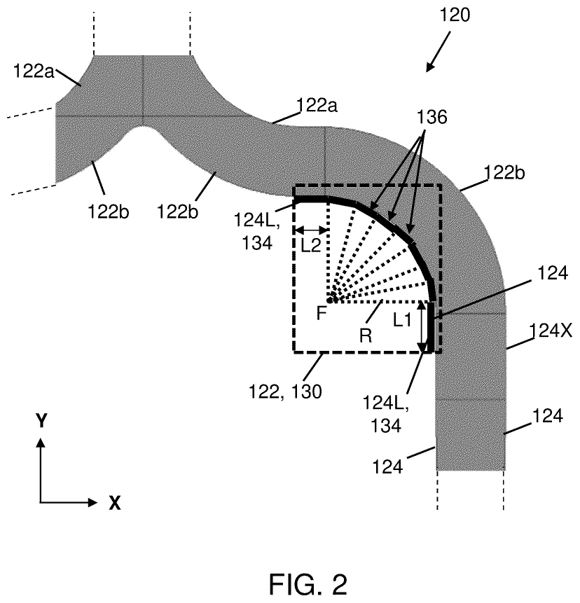

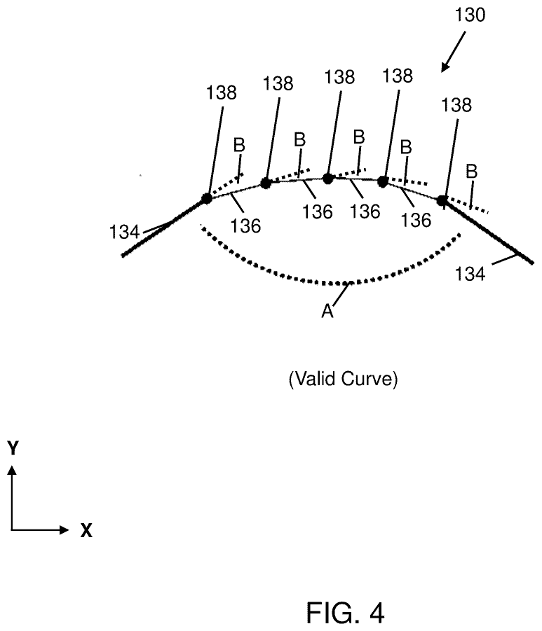

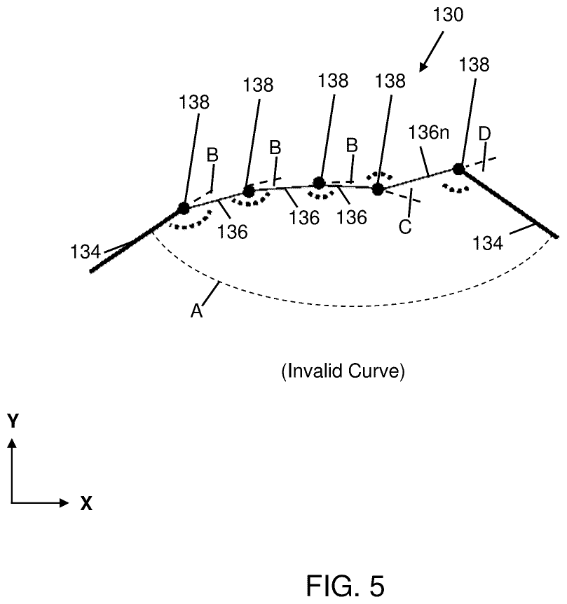

Turning to FIG. 2, an expanded view of a curved feature 120 with various curvilinear intervals 122 therein is shown. Curved features 120, as discussed, may indicate a waveguide and/or similar feature to be fabricated from layout 100 (FIG. 1). Curved features 120 may not have entirely curvilinear edges, but rather, may include a combination of curvilinear intervals 122 and non-curvilinear intervals 124. Curvilinear intervals 122 and non-curvilinear intervals 124, together, define the edge shape of curved feature 120. Non-curved features 110 (FIG. 1) thus can be defined as any feature lacking at least one curvilinear interval 122 therein. Non-curvilinear intervals 124 may be distinguishable from curvilinear intervals 122 by extending linearly for at least a minimum length, e.g., approximately five-thousand nanometers (nm). Each curvilinear interval 122 is further classifiable as being a concave arc 122a or a convex arc 122b. For example, the orientation of non-curvilinear intervals 124 may identify each curvilinear interval as including concave arc 122a or convex arc 122b. In this case, convex arcs 122b are intervals where the connecting non-curvilinear intervals 124 have an angle that traverses the interior of the polygon by an angle less than 180 degrees. Concave arcs 122a are those where the connecting non-curvilinear intervals 124 have an angle that traverses the interior of the polygon by an angle of over 180 degrees. Regardless of whether a particular curvilinear interval 122 is concave or convex, embodiments of the disclosure are operable to convert curvilinear intervals 122 into a series of interconnected linear segments to approximate the same shape in a manufactured product, while maintaining manufacturability from layout 100. Furthermore, embodiments of the disclosure need not modify layout 100 to manufacture curvilinear intervals unless other characteristics of curvilinear intervals 122 prevent manufacturability. Any characteristics of curvilinear intervals 122 preventing manufacturability, furthermore, are detectable in methods according to the disclosure as described herein (e.g., regarding FIGS. 4-5).

Methods of the disclosure include identifying any curved features 120 in layout 100 (FIG. 1), e.g., using any currently known or later developed image analysis and/or recognition techniques to identify any curvilinear intervals 122 between two “endlines.” That is, identifying two non-curvilinear intervals 124 on opposite ends of one curvilinear interval 122. An “endline” refers to any non-curvilinear interval 124 connected to one end of a corresponding curvilinear interval 122 and having a length greater than a predefined threshold. In the example of FIG. 2, curvilinear interval 122 (see dark black line) spans an approximately perpendicular angle, i.e., approximately 90°, between two non-curvilinear intervals 124L, each defining one endline. One non-curvilinear interval 124L has a first length L1 defined as the distance between curvilinear interval 122 and the edge of an adjacent non-curved shape 124X in curved feature 120. Non-curvilinear interval 124L is an endline of curvilinear interval 122 and has a length of at least a predefined threshold such that any length below this threshold is considered part of curvilinear part of curvilinear interval 122. Another non-curvilinear interval 124L has a second length L2 between curvilinear interval 122 and another curvilinear interval 122 (i.e., convex arc 122b in FIG. 2).

According to methods of the disclosure, curvilinear interval 122 can be represented as a linear model 130 where non-curvilinear intervals 124 are represented as endlines 134, and where a plurality of linear segments 136, each having a same orientation differential relative to an adjacent linear segment 136 or respective endline 134, connect two endlines 134 together. That is, “orientation differential” indicates an angle of a respective linear segment 136 relative to an adjacent linear segment 136 or respective endline 134. Each endline 134 has a length L1, L2 that is greater than the length of each linear segment 136 in linear model 130. Curvilinear interval 122 and its corresponding plurality of linear segments 136 in linear model 130 each may have approximately the same radius relative to a focal point F. Embodiments of the disclosure thus are operable to identify curved feature(s) 120 in layout 100 (FIG. 1) and create linear model 130 for manufacturing portions of curved feature(s) 120.

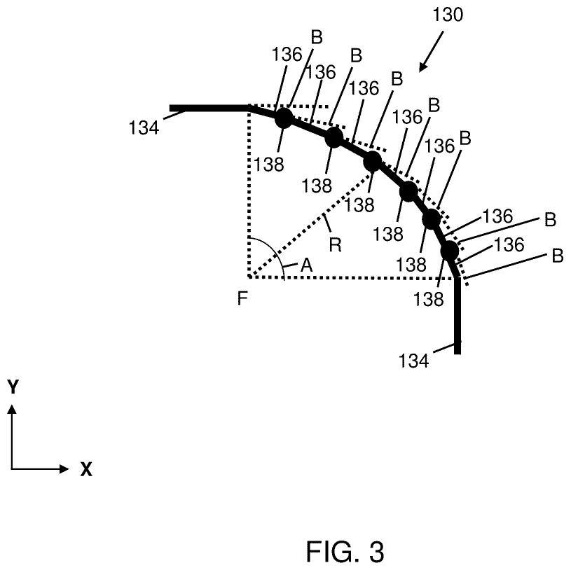

Referring to FIGS. 2 and 3 together, in which FIG. 3 provides a magnified view of linear model 130 for curved feature 120 shown only in FIG. 2, further features of linear model 130 are described. The conversion of curvilinear interval 122 into linear model 130 includes calculating a feature angle A between the two non-curvilinear intervals 124 that each define one endline 134 of linear model 130. In the example of FIGS. 2 and 3, feature angle A (FIG. 3 only) is approximately ninety degrees, and for clarity of illustration is measured at the focal point of curvilinear interval 122 and plurality of linear segments 136. To sufficiently approximate the characteristics of curvilinear interval 122, each linear segment 136 spans between a pair of vertices 138 each having approximately a same radius R from focal point F. Radius R can be calculated from layout 100 before linear model 130 is generated. Radius R, more specifically, can be calculated according to the formula:

$$Radius = \frac{L * 360}{A * 2 * Pi}$$

Where “L” indicates the length of curvilinear interval 122, “A” indicates the feature angle, and “Pi” (π) indicates the universal mathematical constant for the ratio of circumference of a circle to its diameter, i.e., approximately 3.14159.

The radius, once calculated, can be used to determine a combined approximate length of linear segments 136 and thus an individual length for each linear segment 136 in linear model 130. Each linear segment 136 may have a same orientation differential B, i.e., the orientation of each successive linear segment 136 relative to one endline 134 increases by a same amount. Together, the linear segments 136 span feature angle A between endlines 134. For instance, where feature angle A is fifteen degrees and there are three linear segments 136 between two endlines 134, the first linear segment 136 may be oriented at five degrees from an endline 134, the second linear segment 136 may be oriented at ten degrees from the same endline 134, and the third linear segment 136 may be oriented at fifteen degrees from the same endline 134, such that all linear segments 136 differ from each other by five degree angles.

The total number of linear segments 136 in linear model 130 may be defined by a user and/or may be based on the size of layout 100, curvilinear segment 122, a feature resolution for any manufacturing devices for creating a device from layout 100, and/or other considerations. In any case, linear model 130 must include plurality of linear segments 136 sized for joining two endlines 134 together while maintaining a same orientation differential and angle B for each linear segment 136. Thus, embodiments of the disclosure include determining whether linear model 130 can be validly created for each curved feature 120 in layout 100, and where desired, modifying layout 100 such that linear model 130 can be created for all curved features 120 therein.

FIGS. 4 and 5 compare a valid curve with an invalid curve to provide criteria for differentiating between such curves in methods of the disclosure. FIG. 4 illustrates a valid curve (i.e., a curve that is manufacturable from layout 100 according to methods of the disclosure), whereas FIG. 5 illustrates an invalid curve (i.e., a curve that is not manufacturable from layout 100 according to methods of the disclosure). The examples shown in FIGS. 4 and 5 do not correspond to any particular area of layout 100 and/or curved feature 120 shown in FIGS. 1 and 2, respectively, and instead are hypothetical examples provided for sake of explanation. As shown in FIG. 4, a valid curve in linear model 130 includes two endlines 134 connected through a corresponding plurality of linear segments 136. Each linear segment 136 is connected to another linear segment 136 or endline 134 at a vertex 138. Linear segments 136 each may have a same orientation differential relative to their preceding endline 134 and/or segment, indicated by angle “B” in FIG. 4. Thus, where the first linear segment 136 has an angle B relative to endline 134, the next linear segment 136 will have angle B relative to the first linear segment 136 and hence has an angle of twice B relative to endline 134. Collectively, the orientation of linear segments 136 is approximately equal to feature angle A between endlines 134.

FIG. 5 depicts an example of an invalid curve, i.e., a linear model 130 that does not enable curvilinear interval(s) 122 it represents to be manufactured from layout 100. As shown, one endline 134 in this example is positionally offset from the other endline 134 along the Y axis by a greater amount than shown in FIG. 4. Here, one or more linear segments 136 do not have a same length or orientation differential. Specifically, one linear segment 136n adjacent the rightmost endline 134 is larger than the other linear segments 136. Additionally, linear segment 136n is offset from another linear segment 136 by an angle C that differs from the orientation differential B for other linear segments 136. Similarly, an angle D between linear segment 136n is different from angles B and C for other linear segments 130 in linear model 130.

Thus, the presence of linear segment 136 indicates that its original curvilinear interval 122 is not divisible into linear segments 136 each having a same orientation differential relative to endlines 134. Embodiments of the disclosure, receive layout 100 (FIG. 1) for a particular product as an input and construct linear models 130 for each curved feature 120 (FIG. 1, 2) in layout 100. Further analysis of the linear models 130 determines whether curvilinear intervals 122 are divisible into pluralities of linear segments 136 each having a same length and orientation differential, or otherwise includes classifying curvilinear interval(s) 122 as being divisible into linear segments 136. Still further analysis further includes modifying layout 100 to change any curvilinear intervals 122 that are not divisible into pluralities of linear segments 136 or causing layout 100 to be manufactured if all curvilinear intervals 122 of curved features 120 can be validly represented with linear models 130.

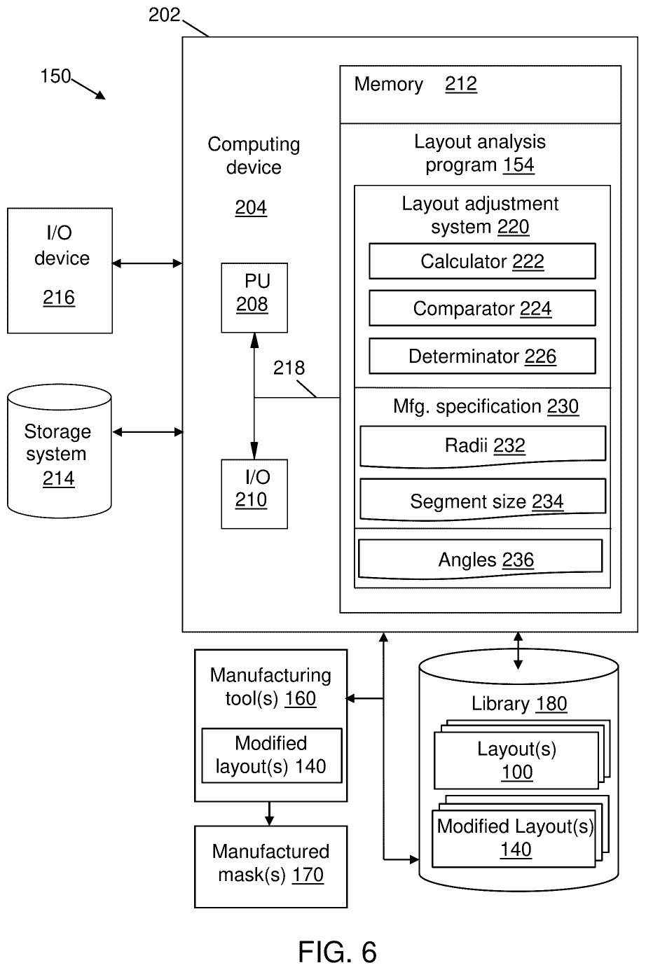

Referring to FIG. 6, an illustrative environment 150 for implementing the methods and/or systems described herein is shown. In particular, a computer system 202 is shown to include computing device 204. Computing device 204 may include, e.g., a layout analysis program 154 which may include, e.g., one or more sub-systems such as layout adjustment system 220, for performing any/all of the processes described herein and implementing any/all of the embodiments described herein.

Environment 150 may include manufacturing tool(s) 160 (e.g., a single manufacturing tool and/or a group of interconnected devices) configured to create manufactured mask(s) 170 from modified layout(s) 140. Manufactured mask(s) 170 may include curved features 120 manufactured using linear models 130 in which the shape of curved feature 120 edges are approximated using pluralities of linear segments 136 (FIGS. 2-5) as discussed herein. Environment 150 may also include a library 180 for storing layout(s) 100 and/or modified layout(s) 140. In accordance with embodiments of the disclosure, library 180 is connected to and modified by a layout analysis program 154 including, e.g., one or more systems for creating modified layout(s) 140 from layout(s) 100. Layout analysis program 154 may be housed, e.g., in a computer system 202, and the various systems and modules therein may operate through one or more processing techniques described herein. Layout analysis program 154 may select particular layout(s) 100 for analysis and modify shapes of certain curved features 120 to create modified layout(s) 140 as discussed herein. Computer system 202 may be in communication with library 180, e.g., according to any currently-known or later developed solution for communicating between data repositories (e.g., library 180), computer systems (e.g., computer system 202), and/or other data repositories discussed herein.

Computer system 202 can aid in the design and manufacture of IC products by causing manufacturing tool(s) 160 to create manufactured mask(s) 170 from layout(s) 100 and/or modified layout(s) 140, and/or converting one or more layout(s) 100 into modified layout(s) 140. The modifying of layout 140 may be accomplished by changing the shape of certain features, such as curved features 120, to enable their conversion into linear model(s) 130 in accordance with geometrical requirements discussed herein. Such geometrical requirements include curvilinear intervals 122 being divisible into a plurality of linear segments 136 each having a same length and same orientation differential relative to any endlines 134 that they connect. Modified layout(s) 140, when created and/or applicable, may exhibit greater manufacturability by the ability to represent all curved features 120 in layout 100 as linear models 130. Layout analysis program 154 may perform functions discussed herein, e.g., by processing data from library 180 for one or more layouts 100. Layout analysis program 154 may generate instructions for adjusting manufacturing tool(s) 160, based on the linear model(s) 130 for a particular layout 100 and/or otherwise created in modified layout(s) 140. Manufacturing tool(s) 160, where applicable, may create manufactured mask 180 based on modified layout 140, instead of layout 100. Modified layout(s) 140 may be stored, e.g., in memory components of computer system 202 for future use. Example procedures for modifying layout 100 to create modified layout 140 are provided in further detail below.

Computer system 202 is shown including a processing unit (PU) 208 (e.g., one or more processors), an I/O component 210, a memory 212 (e.g., a storage hierarchy), an external storage system 214, an input/output (I/O) device 216 (e.g., one or more I/O interfaces and/or devices), and a communications pathway 218. In general, processing unit 208 may execute program code, such as layout analysis program 154, which is at least partially fixed in memory 212. While executing program code, processing unit 208 may process data, which may result in reading and/or writing data from/to memory 212 and/or storage system 214. Pathway 218 provides a communications link between each of the components in environment 150. I/O component 210 may include one or more human I/O devices, which enable a human user to interact with computer system 202 and/or one or more communications devices to enable a system user to communicate with the computer system 202 using any type of communications link. To this extent, layout analysis program 154 may manage a set of interfaces (e.g., graphical user interface(s), application program interface(s), etc.) that enable system users to interact with layout analysis program 154. Further, layout analysis program 154 may manage (e.g., store, retrieve, create, manipulate, organize, present, etc.) data, through several modules contained within a layout adjustment system 220. Layout adjustment system 220 is shown by example as being a sub-system of layout analysis program 154.

As noted herein, layout analysis program 154 may include layout adjustment system 220. In this case, various modules (calculator 222, comparator 224, determinator 226, and collectively “modules”) of layout adjustment system 220 may enable computer system 202 to perform a set of tasks used by layout analysis program 154 and may be separately developed and/or implemented apart from other portions of layout analysis program 154. Calculator 222 can implement various mathematical computations in processes discussed herein. Comparator 224 can compare two quantities and/or items of data in processes discussed herein. Determinator 226 may, e.g., make logical determinations based on compliance or non-compliance with various conditions in processes discussed herein. One or more modules 222, 224, 226, may use algorithm-based calculations, look up tables, software code, and/or similar tools stored in memory 212 for processing, analyzing, and operating on data to perform their respective functions. Each module discussed herein may obtain and/or operate on data from exterior components, units, systems, etc., or from memory 212 of computing device 204.

Layout analysis program 154 may also include a catalogue of data expressed as a manufacturing specification (“mfg. specification”) 230 which defines acceptable design characteristics and manufacturing parameters for layout(s) 100. Manufacturing specification 230 may include a listing of metrics for evaluating whether the design of each layout 100 is acceptable, e.g., a radii field 232 for defining the minimum radius for any curvilinear intervals 124, a segment size field 234 for defining minimum and/or maximum segment sizes of each plurality of linear segments 136 in linear model(s) 130, and angles field 236 defining acceptable angles between non-curvilinear intervals 124 connected by curvilinear intervals 122. Other types of fields, where desired or applicable, also may be included in manufacturing specification 230. Other rules and/or forms of reference measurements, values, etc., may additionally or alternatively be stored in different fields of manufacturing specification 230. Layout adjustment system 220 and modules 222, 224, 226 thereof may cross-reference and apply data within manufacturing specification 230 to implement various processes according to the disclosure, e.g., determining whether linear models 130 can be generated for all curved features 120 in layout 100 and/or whether certain linear models 130 violate predetermined manufacturability requirements.

In addition to working in conjunction with manufacturing specification 230, layout adjustment system 220 may manipulate, interpret, and analyze various forms of information in library 180, including one or more existing layout(s) 100 for one or more individual mask layers or products. In addition, layout adjustment system 220 may generate modified layout(s) 140 to enable manufacturing of any curved features 120 and save modified layout(s) 140 in library 180. In further embodiments, layout analysis program 154 may generate a set of instructions which in turn create modified layout(s) 140 from layout(s) 100 on library 180. Library 180 may form part of, or otherwise may be communicatively coupled to, computing device 204 through any individual or combination of physical and/or wireless data coupling components discussed herein. Some attributes of layout(s) 100 and/or modified layout(s) 140 may be converted into a data representation (e.g., a data matrix with several values corresponding to particular attributes) and stored electronically, e.g., within library 180, memory 212 of computing device 204, storage system 214, and/or any other type of data cache in communication with computing device 204.

Images and/or other representations of layout(s) 100 may additionally or alternatively be converted into data inputs or other inputs to layout analysis program 154 with various scanning or extracting devices, connections to independent systems (e.g., library 180), and/or manual entry of a user. As an example, e.g., a user of computing device 204 could manually input layout(s) 100 and/or other forms of information to layout analysis program 154. Layout analysis program 154 of computing device 204 may output modified layout(s) 140, and in some cases may automatically adjust operation of manufacturing tool(s) 160 based on modified layout(s) 140 and/or instructions 246.

Computer system 202 may be operatively connected to or otherwise in communication with manufacturing tool(s) 160 having one or more manufacturing devices configured to construct IC masks from layouts 100 and modified layouts 100, e.g., as instructed by layout adjustment system 220 for preventing corner violations as discussed herein. Computer system 202 may be embodied as a unitary device in a semiconductor manufacturing plant coupled to manufacturing tool 160 and/or other devices, or may be multiple devices each operatively connected together to form computer system 202. Embodiments of the present disclosure may thereby include using layout analysis program 154 to convert layout(s) 100 into modified layout(s) 140 by removing certain curved features 120 from layout 100 and inserting new versions of the removed curved features 120. As discussed herein, embodiments of the present disclosure may provide instructions for adjusting manufacturing tool(s) 160 based on modified layout(s) 140, e.g., based on where certain curved features 120 are added, modified or removed. Where computer system 202 includes multiple computing devices, each computing device may have only a portion of layout analysis program 154 and/or layout adjustment system 220 (including, e.g., modules 222, 224, 226) fixed thereon. However, it is understood that computer system 202 and layout adjustment system 220 are only representative of various possible equivalent computer systems that may perform a process described herein. Computer system 202 may obtain or provide data, such as data stored in memory 212 or storage system 214, using any solution. For example, computer system 202 may generate and/or be used to generate data from one or more data stores, receive data from another system, send data to another system, etc.

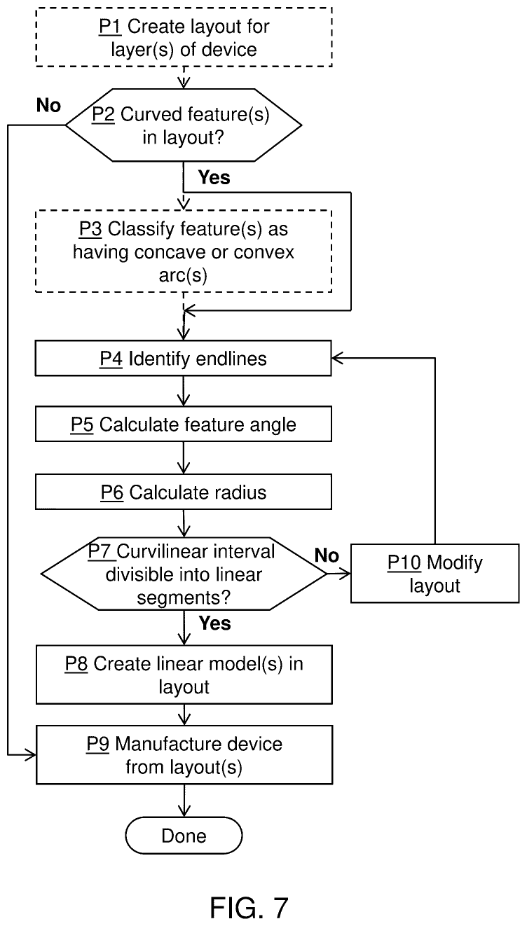

Turning to FIGS. 1, 2, 6, and 7 together, illustrative processes are shown for creating modified layout(s) 140 from layout(s) 100 to determine whether linear models 130 can be created for all curved features 120, creating such linear models 130 where possible, using linear models to manufacture a product from layout 100, and/or modifying layout 100 to create modified layout 140. The steps and processes depicted in FIG. 7 may be implemented, e.g., with components of layout analysis program 154, one or more modules 222, 224, 226 of layout adjustment system 220, and/or other components of computer system 202 described herein by example. A single and/or repeated execution of the processes discussed herein may allow for repeated use of manufacturing tool(s) 160 to manufacture masks for various layers and products while providing greater manufacturability for any curved features 120. In the example processes discussed herein, layout 100 will generally be described as including at least one curved feature 120, with some alternative examples referring to mask layouts with multiple curved features 120 and/or modified layouts 140 in which certain curved features 120 have been modified or replaced. It is also understood that the present disclosure may be implemented with respect to multiple layouts 100 simultaneously and/or sequentially, with each layout's 100 non-curved features 110 and/or curved features 120 having any conceivable dimensions, in any conceivable number, etc.

Methods of the disclosure may initially include process P1 of creating layout 100 for one or more layers of a device, e.g., any conceivable device incorporating IC structures therein. Layout 100 as discussed herein may include non-curved features 110 and/or curved features 120. Methods of the disclosure are directed toward identifying any curved features 120 in layout 100 and converting any curvilinear intervals 122 therein into corresponding linear models 130 to improve manufacturability and/or modify layout 100 to reduce manufacturing challenges. In some cases, process P1 may be performed by another party before methods of the disclosure are implemented, in which case any other processes described herein may be implemented on a pre-existing layout 100 without significant differences. Process P2 of the disclosure may include determining whether curved features 120 are present in layout 100. This process may include, e.g., extracting or otherwise identifying a plurality of non-orthogonal segments having a threshold length from layout 100. In the case where no curved features 120 are present (i.e., “no” at process P2), further operations may include manufacturing a device from layout 100 (i.e., implementing process P9 discussed herein) without further analysis.

Embodiments of the disclosure include further analysis of one or more curved features 120 present in layout 100. Upon determining that curved feature(s) 120 is/are present in layout 100 (i.e., “Yes” at process P2), methods of the disclosure may proceed to further operations for creating linear model(s) 130 for curved feature(s) 120 to aid in manufacturability or prevent manufacturing errors. Optionally, the method may include process P3 of classifying curvilinear interval(s) 122 of curved feature 120 as being concave arcs 122a (FIG. 2 only) or convex arcs 122b (FIG. 2 only). As discussed herein, the classifying in process P3 may include determining concavity or convexity. For example, the type of curvilinear interval may be identified by the orientation of non-curvilinear intervals 124. In this case, a convex interval is an interval where non-curvilinear intervals 124 have an angle that traverses the interior of the polygon less than 180 degrees, and a concave interval is an interval where non-curvilinear intervals 124 have an angle that traverses the interior of the polygon greater than 180 degrees. The classifying in process P3, where implemented, may aid in calculating the radius of any curvilinear intervals 122 by reference to a particular orientation, and/or may aid in determining the orientation differential for each segment 136 of linear model 130 in further processing. In some implementations, process P3 may be omitted, in which case other calculations herein may be implemented without regard to the concave or convex geometry of each curvilinear interval 122.

Further operations may include process P4 of identifying two non-curvilinear intervals 124 of curved feature 120 having at least a threshold length and denoting such non-curvilinear intervals 124 as endlines 134 for linear model 130. The threshold length may be calculated by reference to any number of physical parameters and/or reference values. In a particular example, the threshold length for distinguishing non-curvilinear interval(s) 124 from other portions of curved feature 120 may be approximately five-thousand nanometers (nm). The identifying in process P4 may be implemented through calculator 222 (i.e., calculating the length of non-curvilinear intervals 124) and determinator 226 (i.e., comparing the calculated length with the threshold length, e.g., five-thousand nm or any other reference value). Upon identifying endlines 134, process P5 of the disclosure may include calculating (e.g., via calculator 222 of layout analysis system 220) the feature angle between endlines 134. The calculated feature angle thus indicates the angular span of a particular curvilinear interval 122 before it is converted into multiple linear segments 136 in additional processing.

In addition to calculating the feature angle between endlines 134 as discussed herein, methods of the disclosure to create linear model 130 may include, e.g., process P6, calculating the radius of curvilinear interval 122. As discussed elsewhere herein, calculator 222 of layout analysis system 220 can calculate the radius (R) for curvilinear interval 122 from layout 100 according to the formula:

$$Radius = \frac{L * 360}{A * 2 * Pi}$$

Where “L” indicates the length of curvilinear interval 122, “A” indicates the feature angle, and “Pi” indicates the universal mathematical constant for the ratio of circumference of a circle to its diameter. The focal point from which the radius is measured may be chosen based on the classifying of curved feature(s) 120 as concave or convex in process P3, as discussed herein. In some cases, processes P4, P5, P6 may be implemented in different orders and/or simultaneously, as the calculations therein provide further data for determining whether curvilinear interval 122 is divisible into linear segments 136, and hence whether curvilinear interval 122 is convertible to linear model 130.

Upon determining the feature angle in process P5 and the radius in process P6, various modules of layout analysis system 220 (e.g., calculator 222, comparator 224, determinator 226 discussed herein) may evaluate in process P7 whether curvilinear interval 122 is divisible into a plurality of linear segments 136. In other words, process P7 evaluates whether curvilinear interval 122 is “valid” by being divisible into segments 136 each having a same length and orientation differential between endlines 134, or “invalid” by not being divisible into segments 136 each having a same length and orientation differential between endlines 134. FIG. 4 discussed herein provides an example of a valid curvilinear segment 122 whereas FIG. 5 provides an example of an invalid curvilinear segment 122.

In some cases, process P7 may also include determining a total number of linear segments 136 based on segment size field 234 of manufacturing specification (i.e., by calculator 222 calculating the number of segments by dividing the span of curvilinear segment 122 by a minimum segment size and rounding up to a particular number of segments). In further implementations, the determining in process P7 may include whether each of the plurality of linear segments 136 in linear model is less than the threshold length (e.g., the threshold lengths for defining endlines 134). In such cases, layout analysis program 154 will determine curvilinear segment 122 to not be divisible into linear segments 136 if the length of such segments exceeds the threshold length.

In cases where curvilinear segment 122 is divisible into segments 136 of identical size and having a same orientation differential (as defined elsewhere herein), i.e., “Yes” at process P7, the method may continue to process P8 of creating linear model 130 in layout 100. The creating of linear model 130 in process P8 may include calculator 222 of layout analysis program 154 replacing applicable curvilinear intervals 122 in layout 100 with linear model 130. In other cases, linear model(s) 130 can be superimposed onto layout 100 or otherwise integrated into its contents. The method then may continue to process P9, where a device is manufactured from layout 100. For the manufactured device, linear segments 136 will approximate the shape of curvilinear intervals 122 in curved features 120. Linear segments 136 being used to create curved features 120 retain the functionality of curved features 120 but provide better manufacturability than directly using manufacturing tool(s) 160 to create curved features 120 directly.

In cases where layout analysis program 154 determines that one or more curvilinear intervals 122 are not divisible into linear segments (e.g., they are “invalid curves” as discussed herein), Process P7 yields a “No” and the method may instead continue to process P10 of modifying layout 100. The modifying of layout 100 may be implemented wholly or partially via layout analysis program 154, e.g., by selecting and replacing non-curved features 110 and/or curved features 120 in layout 100 with differently shaped non-curved features 110 and/or curved features 120. Process P10 thus produces modified layout(s) 140 from layout 100, and subsequent operations may be implemented on modified layout(s) 140 instead of layout 100. Thereafter, processes P4, P5, and P6 may be re-implemented with modified layout 140 before redetermining whether curvilinear interval(s) 122 in modified layout 140 are divisible into linear segments 136 of uniform length and each having a same orientation differential. Once process P7 yields a “yes” determination, processes P8, P9 may be implemented via modified layout 140 instead of layout 100. Layout 100 and modified layout 140, independently of the processing discussed herein, may be recorded in library 180 or manufacturing specification 230 to provide training and/or reference data for analysis and/or modifying of other layouts 100, e.g., for other layers, devices, etc.

As will be appreciated by one skilled in the art, aspects of the present disclosure may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be used. A computer readable storage medium may be, for example, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, e.g., verification languages such as Calibre, ICV, and/or PVS. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the layout, functionality, and operation of possible implementations of systems, methods, and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

As used herein, the term “configured,” “configured to” and/or “configured for” may refer to specific-purpose patterns of the component so described. For example, a system or device configured to perform a function may include a computer system or computing device programmed or otherwise modified to perform that specific function. In other cases, program code stored on a computer-readable medium (e.g., storage medium), may be configured to cause at least one computing device to perform functions when that program code is executed on that computing device. In these cases, the arrangement of the program code triggers specific functions in the computing device upon execution. In other examples, a device configured to interact with and/or act upon other components may be specifically shaped and/or designed to effectively interact with and/or act upon those components. In some such circumstances, the device is configured to interact with another component because at least a portion of its shape complements at least a portion of the shape of that other component. In some circumstances, at least a portion of the device is sized to interact with at least a portion of that other component. The physical relationship (e.g., complementary, size-coincident, etc.) between the device and the other component may aid in performing a function, for example, displacement of one or more of the device or other component, engagement of one or more of the device or other component, etc.

Embodiments of the disclosure may provide various technical and commercial advantages, examples of which are discussed herein. Methods of the disclosure reduce the time and resource budget otherwise needed to implement optical proximity correction (OPC) on layouts having curved features 120, as instructions to manufacture curved lines with manufacturing tools 160 pose a higher risk of design rules violation. The linear segments 136 of linear model 130, effectively function as “ad hoc” designs for curved features 120 that would otherwise be difficult to print. The disclosure, moreover, is particularly suitable for manufacture of photonic integrated circuit (PIC) devices, high voltage technology applications, radio frequency (RF) millimeter wave devices, and/or other devices incorporating similar structural elements. In addition, the use of linear models 130 with layouts 100 reduces the time and cost of debugging errors as the use of linear models 130 for curved features 120 reduces or altogether prevents errors that would otherwise arise from forming curved structures in a device.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying, within an integrated circuit (IC) layout, a curved feature including a first endline and a second endline each having at least a threshold length and a curvilinear interval connecting the first endline to the second endline;
calculating a feature angle and a radius of the curvilinear interval between the first endline and the second endline;
determining, based on the feature angle and the radius, whether the curvilinear interval is divisible into a plurality of linear segments each having a same orientation differential relative to the first endline and the second endline; and
manufacturing an IC from the layout based on the curvilinear interval and the plurality of linear segments in response to curvilinear interval being divisible into the plurality of linear segments.

2. The method of claim 1, further comprising modifying the IC layout in response to determining the curvilinear interval is not divisible into the plurality of linear segments.

3. The method of claim 2, further comprising repeating the calculating and the determining following modifying the IC layout.

4. The method of claim 1, wherein the determining further includes determining whether each of the plurality of linear segments has a length less than the threshold length.

5. The method of claim 1, further comprising classifying the curvilinear interval as a concave arc or a convex arc based on whether a radius of the curvilinear interval passes through the curved feature, wherein calculating the feature angle and the radius of the curvilinear interval is further based on whether the curved feature is a concave arc or a convex arc.

6. The method of claim 1, wherein the curved feature includes a portion of a waveguide within the IC layout.

7. The method of claim 1, wherein the threshold length is approximately five thousand nanometers.

8. A computer program product stored on a computer readable storage medium, the computer program product comprising program code, which, when being executed by at least one computing device, causes the at least one computing device to:
identify, within an integrated circuit (IC) layout, a curved feature including a first endline and a second endline each having at least a threshold length and a curvilinear interval connecting the first endline to the second endline;
calculate a feature angle and a radius of the curvilinear interval between the first endline and the second endline;
classify, based on the feature angle and the radius, the curvilinear interval as divisible into a plurality of linear segments each having a same orientation differential relative to the first endline and the second endline; and
cause a manufacturing device to manufacture an IC from the layout based on the curvilinear interval and the plurality of linear segments in response to curvilinear interval being divisible into the plurality of linear segments.

9. The computer program product of claim 8, further comprising program code for modifying the IC layout in response to determining the curvilinear interval is not divisible into the plurality of linear segments.

10. The computer program product of claim 9, further comprising program code for repeating the calculating and the determining following modifying the IC layout.

11. The computer program product of claim 8, wherein the program code for classifying further identifies whether each of the plurality of linear segments has a length less than the threshold length.

12. The computer program product of claim 8, further comprising program code for classifying the curvilinear interval as a concave arc or a convex arc based on whether a radius of the curvilinear interval passes through the curved feature, wherein calculating the feature angle and the radius of the curvilinear interval is further based on whether the curved feature is a concave arc or a convex arc.

13. The computer program product of claim 8, wherein the curved feature includes a portion of a waveguide within the IC layout.

14. A system comprising:
a computing device;
an I/O component operatively coupled to the computing device; and
a memory operatively coupled to the computing device,
wherein the computing device includes logic and is configured to perform a method including:
identifying, within an integrated circuit (IC) layout, a curved feature including a first endline and a second endline each having at least a threshold length and a curvilinear interval connecting the first endline to the second endline;
calculating a feature angle and a radius of the curvilinear interval between the first endline and the second endline;
determining, based on the feature angle and the radius, whether the curvilinear interval is divisible into a plurality of linear segments each having a same orientation differential relative to the first endline and the second endline; and
manufacturing an IC from the layout based on the curvilinear interval and the plurality of linear segments in response to curvilinear interval being divisible into the plurality of linear segments.

15. The system of claim 14, wherein the method further includes modifying the IC layout in response to determining the curvilinear interval is not divisible into the plurality of linear segments.

16. The system of claim 15, wherein the method further includes repeating the calculating and the determining following modifying the IC layout.

17. The system of claim 14, wherein the determining further includes determining whether each of the plurality of linear segments has a length less than the threshold length.

18. The system of claim 14, wherein the method further includes classifying the curvilinear interval as a concave arc or a convex arc based on whether a radius of the curvilinear interval passes through the curved feature, wherein calculating the feature angle and the radius of the curvilinear interval is further based on whether the curved feature is a concave arc or a convex arc.

19. The system of claim 14, wherein the curved feature includes a portion of a waveguide within the IC layout.

20. The system of claim 14, wherein the threshold length is approximately five thousand nanometers.
